(19) United States
(12) Patent Application Publication
(10) Pub. No.: US 2019/0377728 A1
(43) Pub. Date: Dec. 12, 2019

(54) METHOD AND SYSTEM FOR DATA ANALYSIS WITH VISUALIZATION

(71) Applicant: Shanghai Development Center of Computer Software Technology, Shanghai (CN)

(72) Inventors: Lizhi Cai, Shanghai (CN); Mingang Chen, Shanghai (CN); Wenjie Chen, Shanghai (CN); Zhenyu Liu, Shanghai (CN); Yun Hu, Shanghai (CN); Jianhua Wu, Shanghai (CN); Wei Song, Shanghai (CN); Dali Chen, Shanghai (CN); Binliang Wu, Shanghai (CN); Lianghe Ling, Shanghai (CN)

(21) Appl. No.: 16/246,906

(22) Filed: Jan. 14, 2019

(30) Foreign Application Priority Data
Jun. 6, 2018 (CN) 201810576090.7

(51) Int. Cl. G06F 16/248; G06F 16/2453

(52) U.S. Cl. CPC G06F 16/248; G06F 16/24539

(57) ABSTRACT

A method and system are provided for data analysis with visualization. The method includes; generating a visual result; generating a second visual result according to the second query condition and the visual parameter; generating a recommended query condition; and generating a final visual result according to the recommended query condition selected by the user. By using the analysis method or system in the present invention, a new query in which the user may be interested is generated based on an original user query, to guide the user to quickly understand knowledge hidden in the data. An analysis result is presented to the user visually, and is more visual, clearer, and easier to understand compared with a numerical calculation result. In addition, the result can be displayed by using a variety of graphics.

### CROSS-REFERENCE TO RELATED APPLICATION

This application claims priority to Chinese application number 201810576090.7, filed on Jun. 6, 2018. The above-mentioned patent application is incorporated herein by reference in its entirety.

### TECHNICAL FIELD

The present invention relates to the data processing field, and in particular, to a method and system for data analysis with visualization.

### BACKGROUND

The rapid development of information technologies has given birth to an era of big data, and big data has become a new non-material production factor following human workers and capital. With the expansion of data scale, it is increasingly difficult to understand and analyze data. Various forms of data are stored in different formats, and it is impossible to examine all the data carefully with a person's energy. Therefore, it is quite difficult for people to find useful knowledge from these huge amounts of data.

With the data visualization technology, data can be transformed to a graphic or an image to be displayed on a screen. This can help a user to have better insight into the data and better perform data analysis based on understanding data. Therefore, visualization is a powerful auxiliary means for data analysis. On one hand, the multi-scale, heterogeneity, and diversity of big data make the data dimension increase, the quality problems such as data duplication and missing become prominent, data becomes more complex, and consequently the features and problems of the data cannot be found quickly and accurately, which brings challenges in traversal and data presentation. On the other hand, facing massive data, users may not be able to accurately express data they are interested in. In conventional data analysis, a data model is established first, and then the parameters of the model are adjusted according to some data samples. If data is quite complex, it is quite difficult to analyze the characteristics, distribution, and relationship of certain attributes of the data by using conventional methods. In addition, although data needed by a user can be found through conventional data query based on a keyword, an interest of the user cannot be speculated to discover new data in which the user is interested.

Thus, it would be desirable to provide a method and system for data analysis with visualization, to resolve a data analysis problem of large-scale and high-dimensional data, and thereby address the above-mentioned problems in the art.

### SUMMARY

To achieve the above object, the present invention provides the following solutions in one embodiment. A data analysis method is provided with visualization, including: obtaining to-be-analyzed data; obtaining a data format and a first query condition that are defined by a user; generating a first visual result according to the data format and the first query condition that are defined by the user and the to-be-analyzed data; obtaining a second query condition and a visual parameter that are defined by the user, where the visual parameter includes a visual type, a visual data display range, a visual color, and a visual size; generating a second visual result according to the second query condition and the visual parameter that are defined by the user and the first visual result; generating a recommended query condition according to a historical query condition by using a recommendation algorithm, for the user to perform selection, where the historical query condition is a query condition used prior to the second query condition, and the historical query condition includes the first query condition; and generating a final visual result according to the recommended query condition selected by the user and the second visual result.

In one aspect, the step of generating a first visual result according to the data format and the first query condition that are defined by the user and the to-be-analyzed data specifically includes: performing field segmentation on the to-be-analyzed data according to the data format, to obtain segmented data; correcting the segmented data to obtain corrected data; filtering data, corresponding to the first query condition, in the corrected data according to the first query condition, to obtain filtered data; and generating the first visual result based on the filtered data.

In another aspect, the first visual result includes a histogram, a pie chart, a broken line chart, an area graph, a scatter diagram, a bar chart, a bubble diagram, a curve fitting chart, a box plot, a jean chart, a matrix graph, a map, a parallel coordinate chart, a radar map, a word cloud chart, and a user-defined visual effect chart.

In a further aspect, the step of generating a second visual result according to the second query condition and the visual parameter that are defined by the user and the first visual result specifically includes: filtering data, corresponding to the second query condition, in the corrected data according to the second query condition, to obtain twice-filtered data; and generating the second visual result according to the twice-filtered data and the visual parameter.

In yet another aspect, after the generating a second visual result, the method further includes: storing the first query condition to a set of the historical query condition.

In one aspect, the generating a recommended query condition according to a historical query condition by using a recommendation algorithm specifically includes: obtaining a correlation matrix R between all attributes of the to-be-analyzed data according to a Pearson correlation coefficient algorithm, where

$$R = [ \begin{matrix}1 & {r}_{12} & … & {r}_{1 n} \\ {r}_{21} & 1 & … & {r}_{2 n} \\ … & … & … & … \\ {r}_{n 1} & {r}_{n 2} & … & 1\end{matrix} ] ;$$

a set of all the attributes of the to-be-analyzed data is (α₁,α₂, . . . , rᵢⱼ is a Pearson correlation coefficient between an attribute αᵢ and an attribute αⱼ, i=1,2, . . . , and j=1,2, . . . ; calculating, according to a formula σⱼ=min rᵢⱼ, a recommendation level σⱼ of an attribute αⱼ that does not exist in a historical query, where αᵢ is an attribute that has existed in the historical query; successively obtaining recommendation levels of all attributes that do not exist in the historical query, to obtain a recommendation level set; sorting elements in the recommendation level set by value, to obtain an element with a smallest value; determining an attribute that is corresponding to the element with a smallest value and that does not exist in the historical query, as a recommended attribute; and adding the recommended attribute to the second query condition; and generating the recommended query condition.

In accordance with another embodiment of the invention, a data analysis system is provided with visualization, including: a to-be-analyzed data obtaining module, configured to obtain to-be-analyzed data; a user-defined data obtaining module, configured to obtain a data format and a first query condition that are defined by a user; a first visual result generation module, configured to generate a first visual result according to the data format and the first query condition that are defined by the user and the to-be-analyzed data; a user interaction module, configured to obtain a second query condition and a visual parameter that are defined by the user, where the visual parameter includes a visual type, a visual data display range, a visual color, and a visual size; a second visual result generation module, configured to generate a second visual result according to the second query condition and the visual parameter that are defined by the user and the first visual result; a recommended-query-condition generation module, configured to generate a recommended query condition according to a historical query condition by using a recommendation algorithm, for the user to perform selection, where the historical query condition is a query condition used prior to the second query condition, and the historical query condition includes the first query condition; and a final visual result generation module, configured to generate a final visual result according to the recommended query condition selected by the user and the second visual result.

In one aspect, the first visual result generation module specifically includes: a segmentation unit, configured to perform field segmentation on the to-be-analyzed data according to the data format, to obtain segmented data; a correction unit, configured to correct the segmented data, to obtain corrected data; a filtering unit, configured to filter data, corresponding to the first query condition, in the corrected data according to the first query condition, to obtain filtered data; and a first visual result generation unit, configured to generate a first visual result based on the filtered data.

In another aspect, the second visual result generation module specifically includes: a second filtering unit, configured to filter data, corresponding to the second query condition, in the corrected data according to the second query condition, to obtain twice-filtered data; and a second visual result generation unit, configured to generate the second visual result according to the twice-filtered data and the visual parameter.

In yet another aspect, the recommended query condition generation module specifically includes: a correlation matrix obtaining unit, configured to obtain a correlation matrix R between all attributes of the to-be-analyzed data according to a Pearson correlation coefficient algorithm, where

$$R = [ \begin{matrix}1 & {r}_{12} & … & {r}_{1 n} \\ {r}_{21} & 1 & … & {r}_{2 n} \\ … & … & … & … \\ {r}_{n 1} & {r}_{n 2} & … & 1\end{matrix} ] ;$$

a set of all the attributes of the to-be-analyzed data is (α₁α₂, . . . , rᵢⱼ is a Pearson correlation coefficient between an attribute αᵢ and an attribute αⱼ, i=1,2, . . . , and j=1,2, . . . ; a recommendation level calculation unit, configured to calculate, according to a formula σⱼ=min rᵢⱼ, a recommendation level σⱼ of an attribute α₁ that does not exist in a historical query, where α₁ is an attribute that has existed in the historical query; a recommendation level set obtaining unit, configured to successively obtain recommendation levels of all attributes that do not exist in the historical query, to obtain a recommendation level set; a sorting unit, configured to sort elements in the recommendation level set by value, to obtain an element with a smallest value; a recommended attribute determining unit, configured to determine an attribute that is corresponding to the element with a smallest value and that does not exist in the historical query, as a recommended attribute; and a recommended query condition generation unit, configured to add the recommended attribute to the second query condition, to generate the recommended query condition.

According to specific embodiments of the present invention, the following technical effects are achieved. According to the present invention, distributed storage and distributed memory computing are used, so that visual exploratory analysis can be performed on large-scale and high-dimensional data, historical query of a user is supported, and an interest of the user can be speculated according to the historical query of the user. In this way, a new query in which the user may be interested is generated based on the original user query, to guide the user to quickly understand knowledge hidden in the data and resolve a problem of data exploratory analysis of the large-scale and high-dimensional data. An analysis result is presented to the user visually, and is more visual, clearer, and easier to understand compared with a numerical calculation result. In addition, the result can be displayed by using a variety of graphics, and a visualization parameter may also be user-defined, to help the user to observe and understand the data from multiple perspectives.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrates one or more embodiments of the invention and, together with the general description given above and the detailed description given below, explains the one or more embodiments of the invention.

FIG. 1 is a schematic flowchart of a data analysis method with visualization according to one embodiment of the invention.

FIG. 2 is a schematic “black box” diagram of a data analysis system with visualization according to another embodiment of the invention.

### DETAILED DESCRIPTION

The following clearly and completely describes the technical solutions in the embodiments of the present invention with reference to the accompanying drawings in the embodiments of the present invention. To make objectives, features, and advantages of the present invention clearer, the following describes embodiments of the present invention in more detail with reference to accompanying drawings and specific implementations.

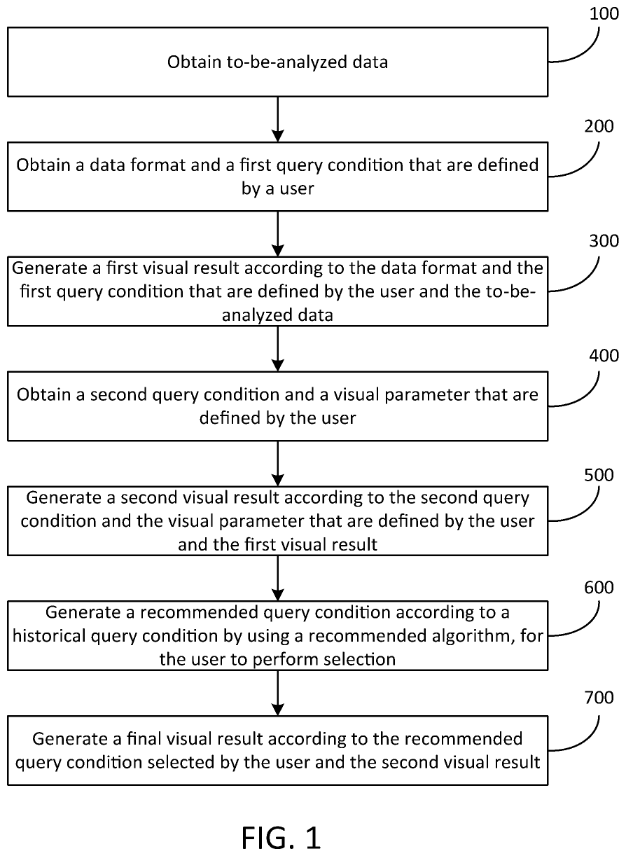

FIG. 1 is a schematic flowchart of a data analysis method with visualization according to the present invention. As shown in FIG. 1, the analysis method includes the following steps:
Step 100. Obtain to-be-analyzed data. A user may directly import the to-be-analyzed data into an analysis system for storage. The to-be-analyzed data may be structured data or may be text-type unstructured data.
Step 200. Obtain a data format and a first query condition that are defined by a user.
Step 300. Generate a first visual result according to the data format and the first query condition that are defined by the user and the to-be-analyzed data. Analysis processing is performed on the to-be-analyzed data imported by the user according to the data format and the first query condition, to generate an appropriate visual model, and then present a visual result of the data to the user, where the result is defined as the first visual result. The visual model includes a histogram, a pie chart, a broken line chart, an area graph, a scatter diagram, a bar chart, a bubble diagram, a curve fitting chart, a box plot, a jean chart, a matrix graph, a map, a parallel coordinate chart, a radar map, a word cloud chart, and a user-defined visual model.

A specific process for Step 300 is as follows: (1) Perform, according to the data format, field segmentation on the to-be-analyzed data imported by the user, to obtain segmented data, where the data format specifies a field segmentation manner, and the segmentation manner may include segmenting by using a separator or segmenting by using a regular expression. (2) Perform data correction on the segmented data to obtain corrected data. A specific method is corresponding to the segmentation manner. If segmentation is performed by using a separator, correction is performed by removing, from the data, a part with an incorrect separator; and if segmentation is performed by using a regular expression, correction is performed by removing, from the data, a part with a mismatched regular expression, and the corrected data is stored. (3) Filter the corrected data according to the first query condition provided by the user, to obtain data satisfying the query condition, to obtain filtered data. (4) Present a visual result of the filtered data in a manner of drawing a table or graph or another manner.

The method further includes:
Step 400: Obtain a second query condition and a visual parameter that are defined by the user, where the visual parameter includes a visual type, a visual data display range, a visual color, and a visual size. This step implements a user interaction function and receiving a new query condition and defined visual parameters of the user to generate a new visual effect.
Step 500: Generate a second visual result according to the second query condition and the visual parameter that are defined by the user and the first visual result and store a historical query condition used prior to this current query of the user to generate a historical query set, where the set includes the first query condition.

A specific process for Step 500 includes the following steps: (1) Filter the stored corrected data according to the second query condition (that is, a new query condition) input by the user, to obtain data satisfying the second query condition, to obtain twice-filtered data. (2) Draw a corresponding chart based on the twice-filtered data according to the visual parameter input by the user, to present a visual result, to obtain the second visual result. (3) Store the second query condition and the visual parameter that are input by the user.

The method further includes:
Step 600: Generate a recommended query condition according to a historical query condition by using a recommendation algorithm, for the user to perform selection. Content that the user may be interested in may be predicted according to the stored historical query condition of the user by using the recommendation algorithm, to generate a query condition, in which the user may be interested, for recommendation for the user to perform selection. Then, the process returns to step 400, a new query condition and visual parameter are obtained, where the query condition herein is the recommended query condition selected by the user or a user defined query condition. The whole process is performed repeatedly until the user obtains a satisfactory data analysis result.

A specific process for Step 600 of generating the recommended query condition is as follows: (1) Obtain a correlation matrix R between all attributes of the to-be-analyzed data according to a Pearson correlation coefficient algorithm, where

$$R = [ \begin{matrix}1 & {r}_{12} & … & {r}_{1 n} \\ {r}_{21} & 1 & … & {r}_{2 n} \\ … & … & … & … \\ {r}_{n 1} & {r}_{n 2} & … & 1\end{matrix} ] ;$$

a set of all the attributes of the to-be-analyzed data is (α₁,α₂, . . . , rᵢⱼ is a Pearson correlation coefficient between an attribute αᵢ and an attribute αⱼ, rᵢⱼ∈[0,1], i=1,2, . . . , and j=1,2, . . . . Assuming that there are n attributes (α₁,α₂, . . . , in the to-be-analyzed data, a set of the n attributes is denoted as A. A column vector corresponding to αᵢ is xᵢ, a column vector corresponding to αⱼ is xⱼ, and a Pearson correlation coefficient between the attribute αᵢ and the attribute αⱼ is as follows:

$${r}_{ij} = \frac{\vert ( {x}_{i} - {\overline{x}}_{i} ) \cdot ( {x}_{j} - {\overline{x}}_{j} ) \vert}{\sqrt{( {x}_{i} - {\overline{x}}_{i} ) \cdot ( {x}_{i} - {\overline{x}}_{i} )} \sqrt{( {x}_{j} - {\overline{x}}_{j} ) \cdot ( {x}_{j} - {\overline{x}}_{j} )}} ,$$

where x̅ᵢ is a mean value of column vectors xᵢ, x̅ⱼ is a mean value of column vectors xⱼ, “*” indicates an inner product of vector. If the attribute αᵢ and the attribute αⱼ are completely correlated, rᵢⱼ is 1; if the attribute αᵢ and the attribute αⱼ are completely independent, rᵢⱼ is 0. (2) Calculate, according to a formula σⱼ=min rᵢⱼ, a recommendation level σⱼ of an attribute αⱼ that does not exist in a historical query, where αᵢ is an attribute that has existed in the historical query. Assuming that an attribute set that has existed in the historical query is Aₑ, and Aₑ∈A, an attribute set that does not exist in the historical query is Aᵤ=A−Aₑ, and each αⱼ∈Aᵤ. (3) Successively obtain recommendation levels of all attributes that do not exist in the historical query, to obtain a recommendation level set. (4) Sort elements in the recommendation level set by value, to obtain an element with a smallest value. (5) Determine an attribute that is corresponding to the element with a smallest value and that does not exist in the historical query, as a recommended attribute. (6) Add the recommended attribute to the second query condition and generate the recommended query condition.

The method further includes:
Step 700. Generate a final visual result according to the recommended query condition selected by the user and the second visual result.

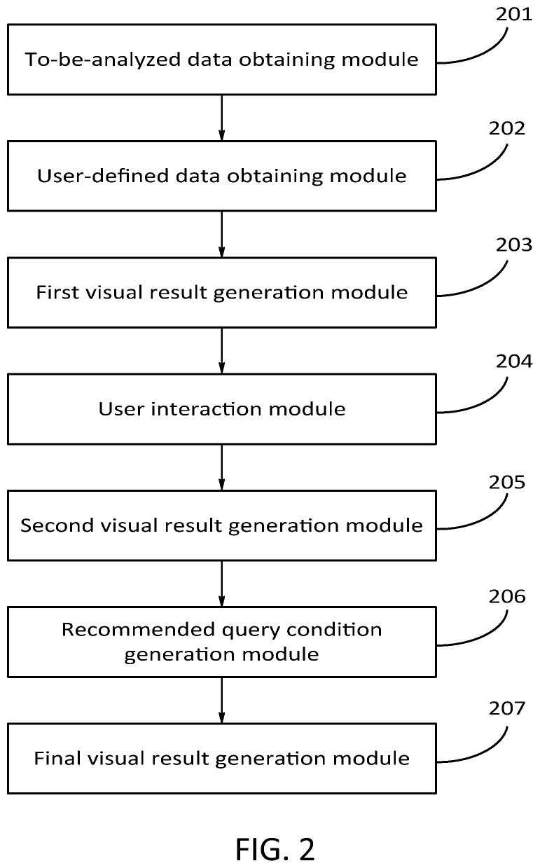

FIG. 2 is a schematic “black box” style structural diagram of a data analysis system with visualization according to another embodiment of the present invention. As shown in FIG. 2, the analysis system includes a to-be-analyzed data obtaining module 201, a user-defined data obtaining module 202, a first visual result generation module 203, a user interaction module 204, a second visual result generation module 205, a recommended query condition generation module 206, and a final visual result generation module 207.

The to-be-analyzed data obtaining module 201 is configured to obtain to-be-analyzed data.

The user-defined data obtaining module 202 is configured to obtain a data format and a first query condition that are defined by a user.

The user communicates with the to-be-analyzed data obtaining module 201 and the user-defined data obtaining module 202 by using the HTTP protocol, and the to-be-analyzed data obtaining module 201 and the user-defined data obtaining module 202 are presented to the user in a form of a webpage and provide a page for submitting data. The data submitted by the user may be structured data or non-structured data, and the data may be uploaded in a form of a file, or may be provided at an access address of online data, a format of the data submitted by the user includes name and type information of each field in the data, or data format information described by using a regular expression, and the data is submitted in a form of a configuration file in an XML format or a JSON format. A query condition submitted by the user is submitted in a form of a query file in an SQL format.

The first visual result generation module 203 is configured to generate a first visual result according to the data format and the first query condition that are defined by the user and the to-be-analyzed data.

The user interaction module 204 is configured to obtain a second query condition and a visual parameter that are defined by the user. The visual parameter includes a visual type, a visual data display range, a visual color, and a visual size. The module is configured to provide an interaction function and receive a feedback of the user to a visual model, including receiving a new query condition of the user, selecting a graph type, selecting a graph data display range, and selecting a graph color and size.

The second visual result generation module 205 is configured to generate a second visual result according to the second query condition and the visual parameter that are defined by the user and the first visual result.

The recommended query condition generation module 206 is configured to generate a recommended query condition according to a historical query condition by using a recommendation algorithm, for the user to perform selection. The historical query condition is a query condition used prior to the second query condition, and the historical query condition includes the first query condition. The module is configured to predict, by using a recommendation algorithm and according to the historical query condition of the user stored in a historical query database, content in which the user is interested, to generate a query condition in which the user may be interested. The historical query database is used to store historical query information of the user. The historical query information includes a query file in an SQL format and a visual parameter that is stored in a form of a configuration file in an XML format or a JSON format.

The recommended query condition generation module 206 supports recommendation that is based on query content, and predicts, according to an existing historical query of the user, an attribute in which the user may be interested, to generate a new query. When a query is recommended, the recommended query condition generation module 206 finds, according to a previous query, an attribute set used by the user in the previous query, and then finds, from an attribute set that is not used by the user and by using a recommended method that is based on an attribute correlation, an attribute that has a smallest correlation with a used attribute, and add the attribute to a query condition, to generate a new query. A value of the attribute with a smallest correlation may include valuable information that the user does not notice previously, so that a result provided by the recommended query condition generation module 206 may not belong to a result of the original query of the user but may be content in which the user is interested. In this way, the user can obtain information of which the user may not be aware but in which the user is indeed interested.

The final visual result generation module 207 is configured to generate a final visual result according to the recommended query condition selected by the user and the second visual result.

The first visual result generation module 203 specifically includes: a segmentation unit, configured to perform field segmentation on the to-be-analyzed data according to the data format, to obtain segmented data; a correction unit, configured to correct the segmented data, to obtain corrected data; a filtering unit, configured to filter data, corresponding to the first query condition, in the corrected data according to the first query condition, to obtain filtered data; and a first visual result generation unit, configured to generate a first visual result according to the filtered data.

The second visual result generation module 205 specifically includes: a second filtering unit, configured to filter data, corresponding to the second query condition, in the corrected data according to the second query condition, to obtain twice-filtered data; and a second visual result generation unit, configured to generate the second visual result according to the twice-filtered data and the visual parameter.

The recommended query condition generation module 206 specifically includes: A correlation matrix obtaining unit, configured to obtain a correlation matrix R between all attributes of the to-be-analyzed data according to a Pearson correlation coefficient algorithm, where

$$R = [ \begin{matrix}1 & {r}_{12} & … & {r}_{1 n} \\ {r}_{21} & 1 & … & {r}_{2 n} \\ … & … & … & … \\ {r}_{n 1} & {r}_{n 2} & … & 1\end{matrix} ] ;$$

a set of all the attributes of the to-be-analyzed data is (α₁,α₂, . . . , rᵢⱼ is a Pearson correlation coefficient between an attribute αᵢ and an attribute αⱼ, i=1,2, . . . , and j=1,2, . . . ; a recommendation level calculation unit, configured to calculate, according to a formula σⱼ=min rᵢⱼ, a recommendation level σⱼ an attribute αⱼ that does not exist in a historical query, where αᵢ is an attribute that has existed in the historical query; a recommendation level set obtaining unit, configured to successively obtain recommendation levels of all attributes that do not exist in the historical query, to obtain a recommendation level set; a sorting unit, configured to sort elements in the recommendation level set by value, to obtain an element with a smallest value; a recommended attribute determining unit, configured to determine an attribute that is corresponding to the element with a smallest value and that does not exist in the historical query, as a recommended attribute; and a recommended query condition generation unit, configured to add the recommended attribute to the second query condition, to generate the recommended query condition.

The analysis system in the present invention provides functions of data distributed storage and data distributed calculation. The analysis system includes a local area network formed by a plurality of computers, and a Linux operating system is installed in each computer big data distributed storage and distributed computing suites based on memory computing are deployed in a computer cluster, to adapt requirements of parallel computing of massive data.

Each embodiment of the present specification is described in a progressive manner, each embodiment focuses on the difference from other embodiments, and the same and similar parts between the embodiments may refer to each other. For a system disclosed in the embodiments, since it corresponds to the method disclosed in the embodiments, the description is relatively simple, and reference can be made to the method description.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. A data analysis method with visualization, wherein the analysis method comprises:
obtaining to-be-analyzed data;
obtaining a data format and a first query condition that are defined by a user;
generating a first visual result according to the data format and the first query condition that are defined by the user and the to-be-analyzed data;
obtaining a second query condition and a visual parameter that are defined by the user, wherein the visual parameter comprises a visual type, a visual data display range, a visual color, and a visual size;
generating a second visual result according to the second query condition and the visual parameter that are defined by the user and the first visual result;
generating a recommended query condition according to a historical query condition by using a recommendation algorithm, for the user to perform selection, wherein the historical query condition is a query condition used prior to the second query condition, and the historical query condition comprises the first query condition; and
generating a final visual result according to the recommended query condition selected by the user and the second visual result.

2. The analysis method according to claim 1, wherein the generating a first visual result according to the data format and the first query condition that are defined by the user and the to-be-analyzed data specifically comprises:
performing field segmentation on the to-be-analyzed data according to the data format, to obtain segmented data;
correcting the segmented data to obtain corrected data;
filtering data, corresponding to the first query condition, in the corrected data according to the first query condition, to obtain filtered data; and
generating the first visual result based on the filtered data.

3. The analysis method according to claim 2, wherein the generating a second visual result according to the second query condition and the visual parameter that are defined by the user and the first visual result specifically comprises:
filtering data, corresponding to the second query condition, in the corrected data according to the second query condition, to obtain twice-filtered data; and
generating the second visual result according to the twice-filtered data and the visual parameter.

4. The analysis method according to claim 1, wherein the first visual result comprises a histogram, a pie chart, a broken line chart, an area graph, a scatter diagram, a bar chart, a bubble diagram, a curve fitting chart, a box plot, a jean chart, a matrix graph, a map, a parallel coordinate chart, a radar map, a word cloud chart, and a user-defined visual effect chart.

5. The analysis method according to claim 1, wherein after the generating a second visual result, the method further comprises:
storing the first query condition to a set of the historical query condition.

6. The analysis method according to claim 1, wherein the generating a recommended query condition according to a historical query condition by using a recommendation algorithm specifically comprises:
obtaining a correlation matrix R between all attributes of the to-be-analyzed data according to a Pearson correlation coefficient algorithm, wherein:
$$R = [ \begin{matrix}1 & {r}_{12} & … & {r}_{1 n} \\ {r}_{21} & 1 & … & {r}_{2 n} \\ … & … & … & … \\ {r}_{n 1} & {r}_{n 2} & … & 1\end{matrix} ] ;$$
a set of all the attributes of the to-be-analyzed data is (α₁,α₂, . . . , rᵢⱼ is a Pearson correlation coefficient between an attribute αᵢ and an attribute αⱼ, i=1,2, . . . , and j=1,2, . . . ,
calculating, according to a formula σⱼ=min rᵢⱼ, a recommendation level σⱼ of an attribute αⱼ that does not exist in a historical query, wherein αᵢ is an attribute that has existed in the historical query;
successively obtaining recommendation levels of all attributes that do not exist in the historical query, to obtain a recommendation level set;
sorting elements in the recommendation level set by value, to obtain an element with a smallest value;
determining an attribute that is corresponding to the element with a smallest value and that does not exist in the historical query, as a recommended attribute; and
adding the recommended attribute to the second query condition and generating the recommended query condition.

7. A data analysis system with visualization, wherein the analysis system comprises:
a to-be-analyzed data obtaining module, configured to obtain to-be-analyzed data;
a user-defined data obtaining module, configured to obtain a data format and a first query condition that are defined by a user;
a first visual result generation module configured to generate a first visual result according to the data format and the first query condition that are defined by the user and the to-be-analyzed data;
a user interaction module, configured to obtain a second query condition and a visual parameter that are defined by the user, wherein the visual parameter comprises a visual type, a visual data display range, a visual color, and a visual size;
a second visual result generation module configured to generate a second visual result according to the second query condition and the visual parameter that are defined by the user and the first visual result;
a recommended-query-condition generation module, configured to generate a recommended query condition according to a historical query condition by using a recommendation algorithm, for the user to perform selection, wherein the historical query condition is a query condition used prior to the second query condition, and the historical query condition comprises the first query condition; and
a final visual result generation module configured to generate a final visual result according to the recommended query condition selected by the user and the second visual result.

8. The analysis system according to claim 7, wherein the first visual result generation module specifically comprises:
a segmentation unit, configured to perform field segmentation on the to-be-analyzed data according to the data format, to obtain segmented data;
a correction unit, configured to correct the segmented data, to obtain corrected data;
a filtering unit, configured to filter data, corresponding to the first query condition, in the corrected data according to the first query condition, to obtain filtered data; and
a first visual result generation unit configured to generate a first visual result based on the filtered data.

9. The analysis system according to claim 8, wherein the second visual result generation module specifically comprises:
a second filtering unit, configured to filter data, corresponding to the second query condition, in the corrected data according to the second query condition, to obtain twice-filtered data; and
a second visual result generation unit configured to generate the second visual result according to the twice-filtered data and the visual parameter.

10. The analysis system according to claim 7, wherein the recommended query condition generation module specifically comprises:
a correlation matrix obtaining unit, configured to obtain a correlation matrix R between all attributes of the to-be-analyzed data according to a Pearson correlation coefficient algorithm, wherein:
$$R = [ \begin{matrix}1 & {r}_{12} & … & {r}_{1 n} \\ {r}_{21} & 1 & … & {r}_{2 n} \\ … & … & … & … \\ {r}_{n 1} & {r}_{n 2} & … & 1\end{matrix} ] ;$$
a set of all the attributes of the to-be-analyzed data is (α₁,α₂, . . . , rᵢⱼ is a Pearson correlation coefficient between an attribute αᵢ and an attribute αⱼ, i=1,2, . . . , and j=1,2, . . . ;
a recommendation level calculation unit, configured to calculate, according to a formula σⱼ=min rᵢⱼ, a recommendation level σⱼ of an attribute αᵢ that does not exist in a historical query, wherein αᵢ is an attribute that has existed in the historical query;
a recommendation level set obtaining unit, configured to successively obtain recommendation levels of all attributes that do not exist in the historical query, to obtain a recommendation level set;
a sorting unit, configured to sort elements in the recommendation level set by value, to obtain an element with a smallest value;
a recommended attribute determining unit, configured to determine an attribute that is corresponding to the element with a smallest value and that does not exist in the historical query, as a recommended attribute; and
a recommended query condition generation unit, configured to add the recommended attribute to the second query condition, to generate the recommended query condition.
